(19) United States
(12) Patent Application Publication
(10) Pub. No.: US 2022/0277733 A1
(43) Pub. Date: Sep. 1, 2022

(54) REAL-TIME COMMUNICATION AND COLLABORATION SYSTEM AND METHOD OF MONITORING OBJECTIVES TO BE ACHIEVED BY A PLURALITY OF USERS COLLABORATING ON A REAL-TIME COMMUNICATION AND COLLABORATION PLATFORM

(71) Applicant: Unify Patente GmbH & Co. KG, Munich (DE)

(72) Inventor: Jurgen Totzke, Poing (DE)

(21) Appl. No.: 17/630,737

(22) PCT Filed: Aug. 14, 2019
(86) PCT No.: PCT/US19/46504

§ 371 Date: Jan. 27, 2022

(51) Int. Cl. G10L 15/08; G10L 15/26

(52) U.S. Cl. CPC G10L 15/08; G10L 15/26

(57) ABSTRACT

The present invention relates to a real-time communication and collaboration system (1), which allows a plurality of users in different locations to communicate and collaborate on a project in real time using a communication network. The system can include a conversation unit (2), in which posts (4) and recordings of utterances of the users and corresponding transcripts (6) are stored. A speech act analyzer unit (7) can be adapted to continuously analyze the posts (4) and transcripts (6) for illocutionary forces, and if an illocutionary force is detected, a corresponding statement (8, 8′, 8″, 8′″, 8″ ″) is creatable. A method of monitoring objectives to be achieved by a plurality of users collaborating on a real-time communication and collaboration platform can include: starting a conversation on the platform (1), searching, in transcribed speech and/or in a post of the user for predetermined keywords or key-phrases for creating a corresponding statement.

### FIELD

The present invention relates to a real-time communication and collaboration system and to a method of monitoring objectives to be achieved by a plurality of users collaborating on a real-time communication and collaboration platform.

### BACKGROUND

In collaboration systems, in particular, in real-time collaboration (RTC-) or live collaboration (LC) systems, at least two users that are situated at different geographical locations are able to collaborate and communicate with each other without time delay using, for example, audio-/video conferencing systems. Thus, the users collaborating and communicating with each other situated at different locations are connected to each other via the Internet. In general, collaboration between a plurality of users on such collaboration platforms aim at solving a specific task or achieving an intended objective.

Moreover, in prior art, such collaboration systems also provide unstructured search tools and algorithms on keywords or participants. However, focal monitoring of the achievement of intended objectives or the solution of the tasks, in prior art collaboration systems is insufficiently supported by such search capabilities.

### SUMMARY

Therefore, the present invention is based on the object to provide a real-time communication and collaboration system and a method of monitoring objectives to be achieved by a plurality of users collaborating on the real-time communication and collaboration platform, according to which an improved and specifically, a focal monitoring is enabled.

The object is solved by a real-time communication and collaboration system having the features according to claim 1, and by a method of monitoring objectives to be achieved by a plurality of users collaborating on the real-time communication and collaboration platform having the features according to claim 7. Preferred embodiments of the invention are defined in the respective dependent claims.

Thus, according to the present invention, a real-time communication and collaboration system is provided, which allows a plurality of users in different locations to communicate and collaborate on a project in real-time using a communication network, wherein the system comprises a conversation unit, in which posts of threads and recordings of utterances of the users and corresponding transcripts are stored, characterized in that the system further comprises a speech act analyzer, SAA, unit adapted to continuously analyze the posts and transcripts for illocutionary forces, and if the speech act analyzer unit detects an illocutionary force, it is further adapted to create a corresponding statement.

Thus, according to the present invention, a real-time communication and collaboration system is realized which allows for improved and specifically, focal monitoring of work processes or collaboration between users of the system. In particular, since according to the present invention, speech act theory on illocutionary forces is advantageously integrated into real-time collaboration systems like Circuit®, users are enabled to conduct more professional interaction and own communication governance. Statement pattern are derived from utterances relating to illocutionary forces. Such statements are complemented with meta-data supporting business workflows and views from the perspective of an individual user, thereby providing a more efficient collaboration system implementing a complementary business workflow based on illocutionary forces recognition for the individual speaker.

According to a preferred embodiment of the invention, the SAA unit is adapted to create, as a first statement, a fact statement, as a second statement, an obligation statement, as a third statement, a status statement, as a fourth statement, a motivation statement, and as a fifth statement, an own feeling statement.

Further, according to a preferred embodiment of the invention, each statement is provided with a timestamp.

According to another preferred embodiment of the invention, the system further comprises a speech act processing unit adapted to manage statistics and adapted to issue a reminder to a user, and/or to provide the created statement to the user.

According to still another preferred embodiment of the invention, the system further comprises an active speaker recognizer, ASR, and a Speech-to-Text transcription engine comprised in a Natural Language Understanding, NLU, unit.

Preferably, the system further comprises a speech act entity management and display means.

Moreover, according to the present invention, a method of monitoring objectives to be achieved by a plurality of users collaborating on a real-time communication and collaboration platform is provided, wherein the method comprises the steps of: starting a conversation on the communication and collaboration platform, recognizing the speech of a user of the plurality of users, and transcribing the speech, searching, in the transcribed speech and/or in a post of the user, for predetermined keywords or predetermined key-phrases in a speech act library comprising general speech act patterns, and, if a keyword or key-phrase from the speech act library is identified in the transcribed speech, and creating, on the basis of the keyword or key-phrase, a corresponding statement for the user.

According to a preferred embodiment of the invention, the method further comprises a step of detecting sentiments for creating a statement for the user.

According to another preferred embodiment of the invention, for each user of the plurality of users, a statement or a statement collection is created.

It also is preferable, if the speech act library comprises general speech act patterns.

Preferable, the speech act library further comprises domain-specific speech act patterns.

According to still another preferred embodiment of the invention, the method further comprises a step of classifying the transcribed speech, in particular, utterances or the posts of the user of the plurality of users, to an illocutionary force category according to the illocutionary force, the illocutionary force being either one of assertive, commissive, declarative, directive, or expressive.

The method may further comprise a step of assigning the identified category as a statement with meta-data to a corresponding conversation item.

Also, the method may further comprise a step of adding the statement to a watch list of the user.

Preferably, the method further comprises a step of adding a due date to the statement.

Other details, objects, and advantages of the telecommunications apparatus method will become apparent as the following description of certain exemplary embodiments thereof proceeds.

### BRIEF DESCRIPTION OF THE DRAWINGS

The invention and exemplary embodiments thereof will be described below in further detail in connection with the drawing.

FIG. 1 is a block diagram showing a real-time collaboration (RTC) platform according to an embodiment of the invention;

FIG. 2 is an exemplary list of statements according to an embodiment of the invention derived from the recognized illocutionary forces described with respect to FIG. 1;

FIG. 3 is a flow chart illustrating an exemplary process of creating statements according to an embodiment of the invention;

FIG. 4A is a flow chart illustrating an exemplary process by which a user may interact based on a watch list;

FIG. 4B is a flow chart illustrating an exemplary process for when a reminder or due date has been reached for a statement;

FIG. 5 is a flow chart illustrating a process according to an embodiment of the invention which may run simultaneous to the process illustrated in FIG. 3 in case the optional “own feeling” statistics is enabled for the system; and

FIG. 6 is a diagram depicting the high-level functional decomposition of a real-time collaboration platform according to an embodiment.

### DETAILED DESCRIPTION OF EXEMPLARY EMBODIMENTS

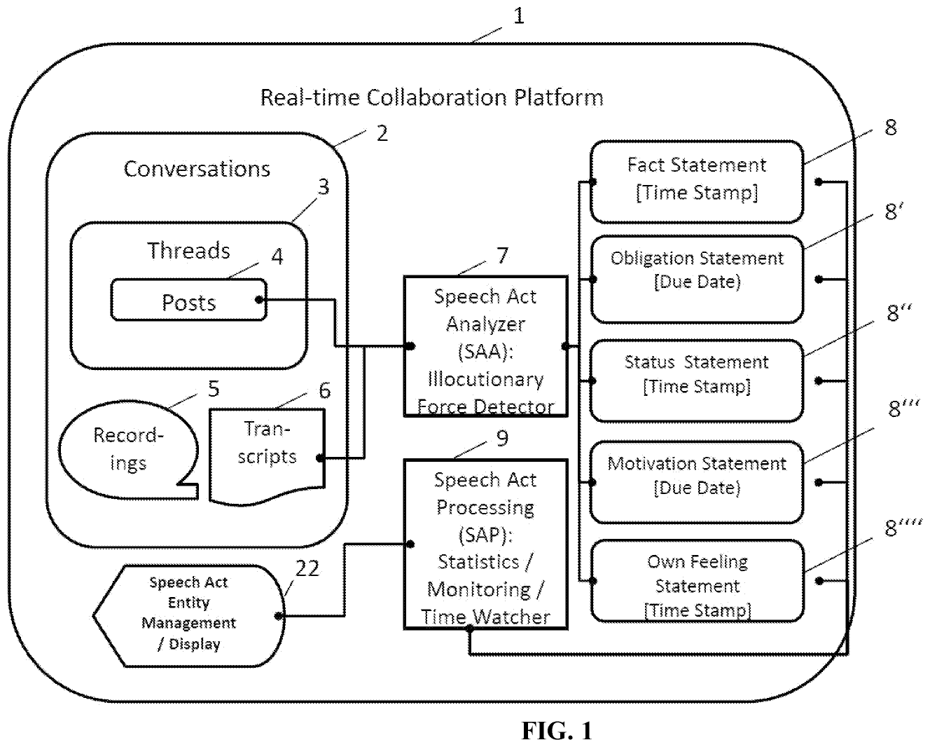

FIG. 1 shows a real-time communication and collaboration (RTC) platform or system 1 according to an embodiment of the invention, which integrates the Speech Act Theory on illocutionary forces, by deriving statement patterns from utterances made by the users relating to illocutionary forces. These statement patterns are then complemented with meta-data supporting business workflows and views from the perspective of the individual user who made the utterances. The real-time communication and collaboration system 1 may be a system as Circuit® available from Unify, or the like. The real-time communication and collaboration system 1 can include at least one communication device that has a non-transitory computer readable medium (e.g. flash memory, a hard drive, etc.) connected to at least one processor (e.g. a microprocessor, a central processing unit, etc.). At least one program can be stored on the non-transitory computer readable medium that is executable by the processor so that the communication device performs one or more methods for hosting of one or more services. The communication device can also include other hardware and/or be connectable to other devices (e.g. input devise, output devices, input/output devices, etc.).

The communication device can be positionable in a network for hosting one or more services available to terminal devices (e.g. tablets, smart phones, laptop computers, personal computers, etc.) and/or other devices. These devices can be communicatively connectable to the communication device to utilize the services offered by the communication device via at least one communication connection (e.g. at least one network connection etc.).

However, before referring to the actual real-time communication and collaboration system 1 illustrated in FIG. 1, a brief description on the general concept of the Speech Act Theory and its implementation the a real-time communication and collaboration system 1 is given.

Human communication research identified as part of Speech Act Theory on verbal or written interaction between humans the notion of illocutionary forces. There are five illocutionary forces given along with typical keywords thereof:
1. Assertive: Commit the speaker to something being the case, e.g., assert, inform, remind, etc.
2. Commissive: Commit the speaker to some future course of action, e.g., commit, promise, accept, etc.
3. Declarative: Change the reality according to the propositional content, e.g., approve, decline, judge, etc.
4. Directive: Attempt to cause the hearer to make some particular action, e.g., request, ask, order, etc.
5. Expressive: Express the attitude or emotions of the speaker, e.g., thank, congratulate, apologize, etc.

The example keywords given above or more complete key-phrases can be used by Natural Language Understanding (NLU) subsystems for keyword spotting identifying relevant utterances and providing the statements from the utterances to the addressee of the utterances.

For identification of the speaker, Automatic Speech Recognition (ASR) may be used. NLU and ASR are typically features of a modern communication/collaboration system. Optionally, in combination with sentiment detection, utterances matching these patterns may be used to create a corresponding statement for the speaker. Note that in the course of a collaboration session, a statement collection is created for every individual contributor.

A selection of keywords or key-phrases may be populated in a speech act library with general speech act patterns and optionally domain-specific speech act patterns, e.g., legal phrases. Such speech act libraries may be used to identify and classify transcribed utterances or posts to an illocutionary force category. The identified category is assigned as a statement with meta-data to a corresponding conversation item. In case of such a statement, a recording or transcript may be indexed for a more precise retrieval.

In a view of the collaboration user interface, a subset of these statement categories with an extracted utterance as “headline” is populated as lists in chronological order and linked to the respective indexed recording or post. In order to facilitate a business workflow, the individual statements are associated with a status including the following states: Monitored, Overdue, Closed, or Hidden. To identify statements overdue, the latter must have been qualified with a due date by the user. Otherwise, a pre-set forget-date automatically hides the entity. Different view modes may be applied to the statement list: In a normal view closed and hidden entities are no longer displayed in the list retaining the user's overview on statements to be pursued. As an alternative view, hidden entities may be made visible again and may be changed to “unhidden”. In a special view the entire history on hidden or closed entities may be browsed or searched for auditing purposes.

Referring now to the embodiment illustrated in FIG. 1, the RTC platform 1 schematically illustrated here comprises a conversation unit 2 including threads 3 and posts 4 as well as audio/video recordings 5 and transcripts 6. The posts 4, transcripts 6, and utterances which are represented by the recordings 5 are continuously analyzed for illocutionary forces (see illocutionary forces 1. to 5. listed above) by the speech act analyzer unit 7. When an illocutionary force is detected, a corresponding statement 8, 8′, 8″, 8′″, 8″″ is created, wherein reference numeral 8 indicates a so-called fact statement, reference numeral 8′ indicates a so-called obligation statement, reference numeral 8″ indicates a so-called status statement, reference numeral 8′″ indicates a so-called motivation statement, and reference numeral 8″″ indicates an so-called own feeling statement. Namely, a detected assertive illocutionary force (see 1. listed above) creates a (relevant) fact statement with a time-stamp that primarily may be used for auditable documentation purposes for which typically the pre-set forget date applies.

Further, a detected commissive illocutionary force (see 2. listed above) creates an obligation statement that may be tracked by right-in-time reminders and due dates for which typically the user sets a due date. The right-in-time reminder may be set automatically as a reasonable fraction of the timeline reaching the due date.

Further, a detected declarative illocutionary force (see 3. listed above) creates status (determination) statements that primarily may be used for auditable documentation purposes for which typically the pre-set forget date applies.

Moreover, a detected directive illocutionary force (see 4. listed above) creates motivation statements that may be tracked by right-in-time reminders and due dates (see 2.) and—if completed—used for auditable documentation.

Finally, a detected expressive illocutionary force (5) creates own feelings statements for which statistics may be displayed allowing the individual user self-assessing her/his communication behavior. The user may start and stop such monitoring periods.

These statements 8, 8′, 8″, 8′″, 8″″ are processed by a speech act processing unit 9, which creates related statistics and which monitors time constraints, and may be provided to the users.

Furthermore, the speech act processing unit 9 provides a corresponding structured view per user according to the statement category, allowing the user to apply state changes, and it also notifies the user when deadlines are due and issues reminders in advance. Also, created statements are cross-linked to their conversation sources (not shown). As the recordings 5 and transcripts 6 contain a time-stamp respectively, the statements can also be linked as an index to the original recording 5 for selective replay or to the original transcript 6 for positioning.

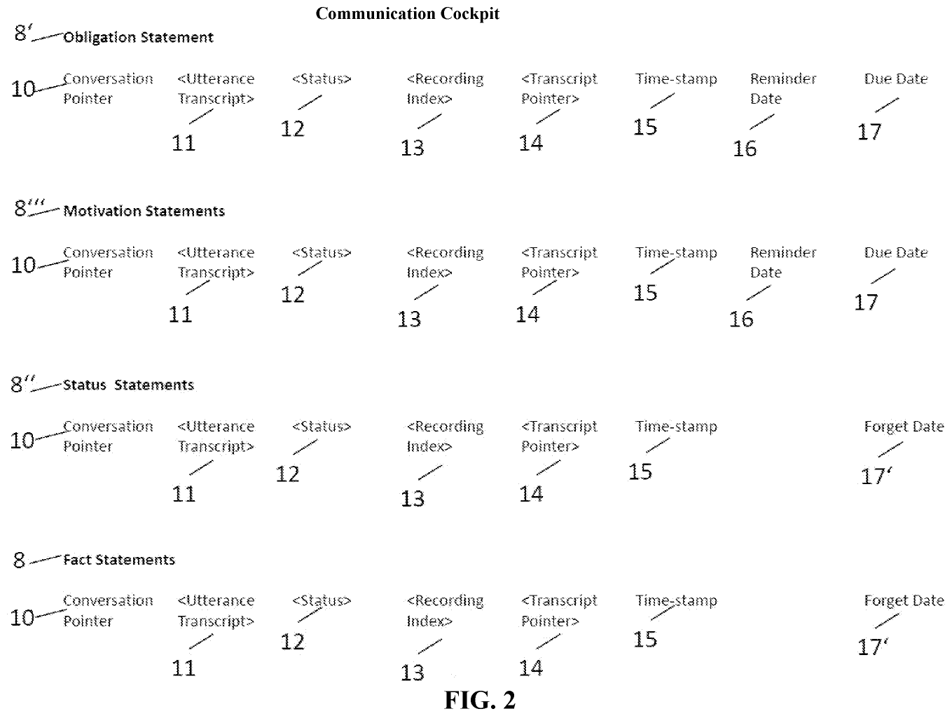

FIG. 2 illustrates the list of statements 8, 8′, 8″, 8′″ derived from the recognized illocutionary forces described above. The entries consist of a conversation pointer 10 by means of which the user may navigate to the corresponding conversation item. The utterance transcript 11 supports the user remembering the topic. The status 12 reflects for a particular statement 8, 8′, 8″, 8′″ the current status depending on the view selected by the user. The recording index 13 allows the user to replay a corresponding recording chunk or the transcript pointer 14 to read the corresponding transcription section. All entries are complemented with a time stamp 15 of their occurrence and certain statements with a pre-configured forget date 17′ or a due date 17. The latter have to be set by the user, a reminder date 16 is set automatically depending of the timeline.

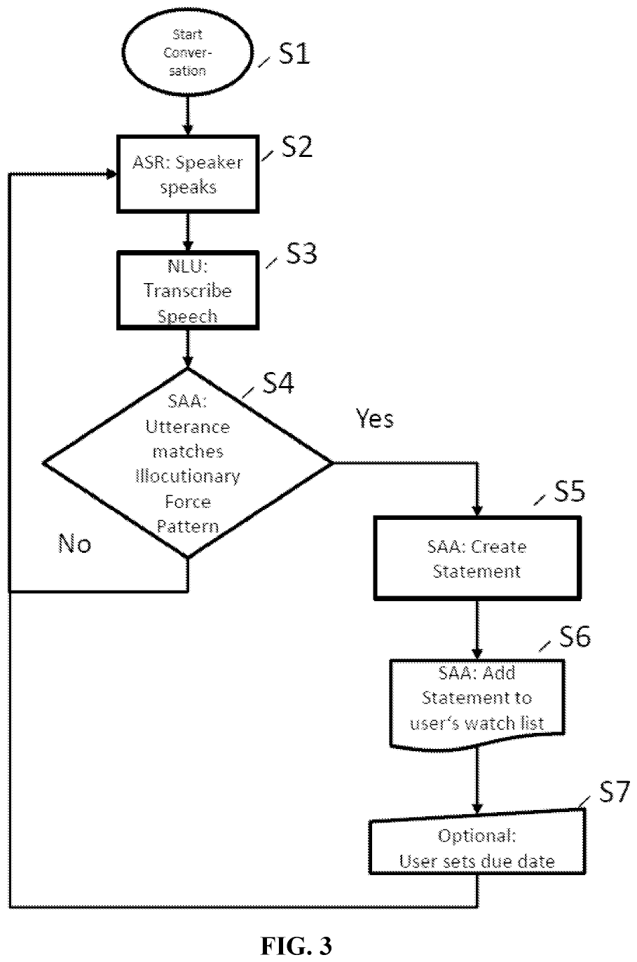

FIG. 3 depicts the process of creating statements (as the statements 8, 8′, 8″, 8′″, and 8′″ described with respect to FIG. 1 and FIG. 2) and populating the latter to a watch list. First, in step S1, the conversation is started on the communication and collaboration system 1 (see FIG. 1). Then, in step S2, the speaker speaks and ASR is activated. In step S3, the NLU subsystem performs transcription of the speech, and in step S4, the Speech Act Analyzer SAA unit 7 determines, whether the utterance matches an illocutionary force pattern. If not, the procedure returns to the initial step S1. If positive, then the SAA, in step S5, creates a statement. In the subsequent step S6, the SAA adds the statement to the user's watch list, and finally, in step S7, which is an optional step, the user may set a due date (see FIG. 2).

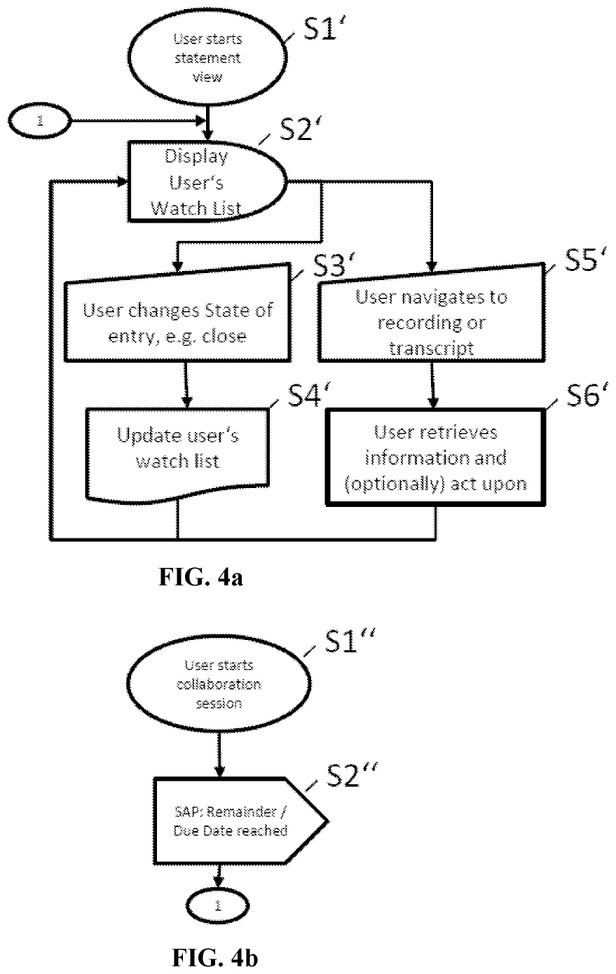

FIG. 4A describes how a user may interact based on a watch list, whereas FIG. 4B illustrates when a reminder or due date has been reached for a statement. As to FIG. 4A, the procedure starts with a user starting the statement view in step S1′. Subsequently, in step S2′, the user's watch list is displayed on a display means (not shown). Then the user may either change the state of entry, e.g., close (step S3′) and subsequently, the user's watch list is updated (step S4′), or alternatively, the user may navigate to recording or transcript in step S5′, whereupon the user, in step S6′, retrieves information and may optionally react upon receipt of the information. According to FIG. 4B, the user, in the initial step S1“, starts a collaboration session. Subsequently, in step S2”, the Speech Act Processing unit SAP 9 issues a reminder to the user, and the procedure continues with “1”.

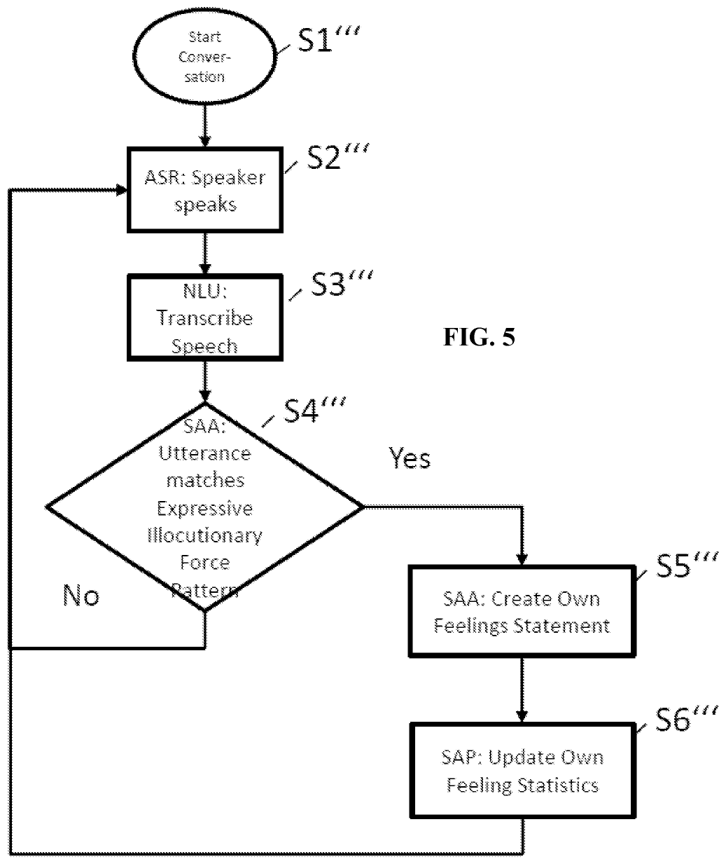

FIG. 5 illustrates a process, which may run simultaneous to the process illustrated in FIG. 3 in case the optional “own feeling” statistics is enabled for the system. Here, in a first initial step S1′″, the conversation at first is started. In step S2′″, the ASR is activated, as a speaker speaks, and in step S3′″, the NLU performs transcription of the speech. Subsequently, in step S4′″, the SAA determines whether the utterance matches an expressive illocutionary force pattern, and if not, then the procedure returns to step S2′″. If positive, then the SAA, in step S5′″, creates an own feelings statement, and then, in step S6′″, the SAP updates the own feelings statistics before the procedure returns to step S2′″.

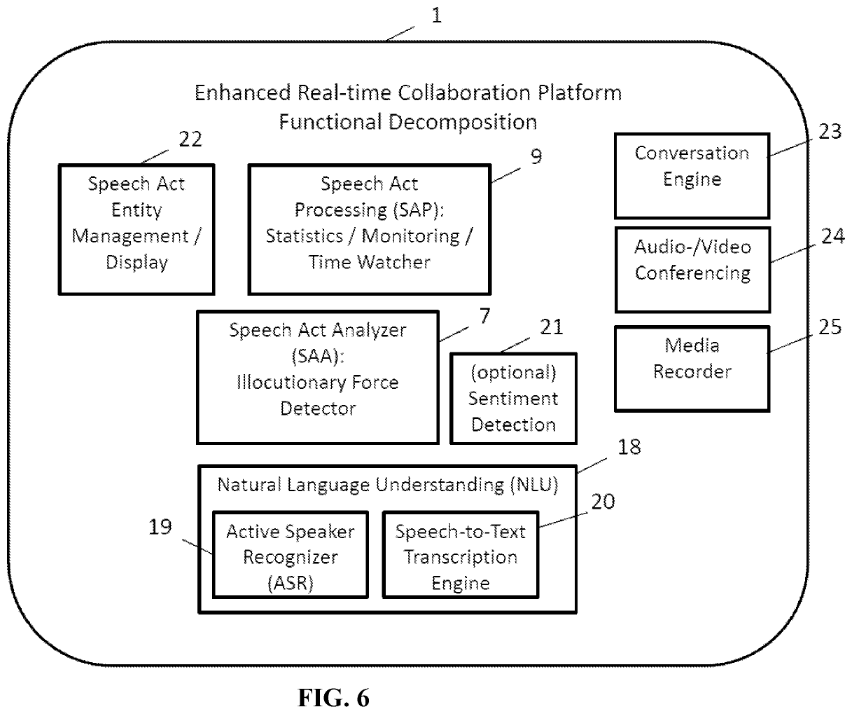

FIG. 6 depicts the high-level functional decomposition of real-time collaboration platform 1 according to an embodiment. As part of the NLU 18, the ASR 19 identifies the speaker so that the created statements may be populated in his/her watch list. The Speech-to-Text transcription engine 20 transcribes the speech to text. The SAA 7 analyses this text to detect Illocutionary force utterances. For an improved detection, the optional sentiment detection means 21 may indicate to the SAA 7 whether a potential Illocutionary force utterance is meant ironic or alike so that no corresponding statements are created. The SAP unit 9 provides for governance of the real-time communication and collaboration system 1. The speech act management/display means 22 provides for the user interface (UI) interacting with the user for the features described above. A conversation engine 23, audio/video conferencing means 24, and a media recorder 25 are typical functional entities of a real-time collaboration platform 1 interacting with the complementary functions as of the system described above.

It is noted that as an alternative embodiment, an analogous concept may be applied to call centers and presented to an agent supporting his/her post-processing of a call. The directive illocutionary force (4.) and the expressive illocutionary force (5.) may be evaluated per agent and presented to the supervisor as an indicator for call center/agent quality.

### REFERENCE NUMERALS UTILIZED IN THE DRAWINGS INCLUDE

1 real-time collaboration system or platform
2 conversation unit
3 threads
4 posts
5 recordings
6 transcripts
7 speech act analyzer unit
8′, 8″, 8′″, 8″″ statements
9 speech act processing unit
10 conversation pointer
11 utterance transcipt
12 status
13 recording index
14 transcript pointer
15 timestamp
16 reminder data
17 due data, 17′ forget data
18 NLU
19 ASR
20 Speech-to-Text transcription engine
21 sentiment detection means
22 speech act management/display means
23 conversation engine
24 audio-/video conferencing means
25 media recorder

It is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of a real-time communication and collaboration platform, a telecommunication system, a communication and collaboration system, and a telecommunication apparatus and methods of making and using the same have been shown and described above, it is to be distinctly understood that the invention is not limited thereto but may be otherwise variously embodied and practiced within the scope of the following claims.

1-15. (canceled)

16. A real-time communication and collaboration system, which allows a plurality of users in different locations to communicate and collaborate on a project in real time using a communication network, wherein the system comprises:
a conversation unit in which posts of threads and recordings of utterances of the users and corresponding transcripts are stored;
a speech act analyzer unit configured to continuously analyze the posts and transcripts for illocutionary forces, and in response to the the speech act analyzer unit detecting an illocutionary force, the speech act analyzer creates a corresponding statement.

17. The real-time communication and collaboration system of claim 16, wherein the speech act analyzer unit is configured to create, as a first statement, a fact statement, as a second statement, an obligation statement, as a third statement, a status statement, as a fourth statement, a motivation statement, and as a fifth statement, an own feeling statement.

18. The real-time communication and collaboration system of claim 16, wherein each statement is provided with a timestamp.

19. The real-time communication and collaboration system of claim 16, wherein the system further comprises a speech act processing unit configured to manage statistics and issue a reminder to a user, and/or to provide the created statement to the user.

20. The real-time communication and collaboration system of claim 16, comprising:
an active speaker recognizer and a Speech-to-Text transcription engine comprised in a Natural Language Understanding unit.

21. The real-time communication and collaboration system of claim 16, wherein the system further comprises a speech act entity management and display device.

22. A method of monitoring objectives to be achieved by a plurality of users collaborating on a real-time communication and collaboration platform, the method comprising:
starting a conversation on the communication and collaboration platform;
recognizing the speech of a user of the plurality of users, and transcribing the speech;
searching, in the transcribed speech and/or in a post of the user, for predetermined keywords or predetermined key-phrases in a speech act library comprising general speech act patterns,
in response to a keyword or key-phrase from the speech act library being identified in the transcribed speech:
creating, on the basis of the keyword or key-phrase, a corresponding statement for the user.

23. The method of claim 22, comprising:
detecting sentiments for creating a statement for the user.

24. The method of claim 22, wherein for each user of the plurality of users, a statement or a statement collection is created.

25. The method of claim 22, wherein the speech act library comprises pre-defined general speech act patterns.

26. The method according to claim 22, wherein the speech act library further comprises domain-specific speech act patterns.

27. The method of claim 22, comprising:
classifying the transcribed speech to an illocutionary force category according to the illocutionary force, the illocutionary force being either one of assertive, commissive, declarative, directive, or expressive.

28. The method of claim 27, wherein the transcribed speech includes utterances or the posts of the user of the plurality of users,

29. The method of claim 27, comprising:
assigning the identified category as a statement with meta-data to a corresponding conversation item.

30. The method of claim 22, comprising:
adding the statement to a watch list of the user.

31. The method of claim 22, comprising:
adding a due date to the statement.
